(19) United States
(12) Patent Application Publication
(10) Pub. No.: US 2026/0312294 A1
(43) Pub. Date: Oct. 8, 2026

(54) Low-Profile Stackable Retroreflective Electromagnetic Markers For Enhanced Automotive Radar Vision

(71) Applicant: The Regents of The University of Michigan, Ann Arbor, MI (US)

(72) Inventors: Jimmy HESTER, Ann Arbor, MI (US); Longyu GUO, Ann Arbor, MI (US); Sepideh GHASEMI, Ann Arbor, MI (US); Aline EID, Ann Arbor,, MI (US)

(73) Assignee: The Regents of The University of Michigan, Ann Arbor, MI (US)

(21) Appl. No.: 19/637,043

(22) Filed: Apr. 2, 2026

Related U.S. Application Data
(60) Provisional application No. 63/783,400, filed on Apr. 4, 2025.

(51) Int. Cl. H01Q 15/14; H01Q 13/02; H01Q 21/29; H01Q 23/00

(52) U.S. Cl. CPC H01Q 15/14; H01Q 13/0233; H01Q 21/29; H01Q 23/00

(57) ABSTRACT

A retrodirective device is presented for use as a road marker. The retrodirective device is comprised of a planar substrate; and a first array of antennas disposed on the substrate. The antennas in the first array of antennas are substrate integrated waveguides and are arranged symmetrically in pairs around an axis located in middle of the substrate, such that antennas in each antenna pair are connected to each other. Each antenna in the first array of antennas may be further defined as a horn antenna.

### FIELD

The present disclosure relates to road markers.

### BACKGROUND

Road markings are essential components of road safety, traffic management, and infrastructure improvement. By offering visual guidance to drivers, they play an important role in ensuring vehicles navigate safely and reliability. Clear and properly maintained markings play a vital role in reducing accidents and improving overall road safety standards. Nevertheless, their effectiveness can be significantly diminished by factors like adverse weather conditions (e.g., fog, rain, snow), low light conditions, and visual obstructions such as overgrown vegetation or poorly maintained signage. According to the research conducted by the Federal Highway Administration (FHWA), around 21% of all traffic accidents are associated with weather conditions. Adverse weather conditions diminish visibility, making it harder for drivers to observe road markings clearly and in a timely manner, thereby increasing collision risks.

With the continuous evolution of autonomous driving technology, vehicles equipped with sensors such as cameras and Light Detection and Ranging (LiDAR) systems can contribute to achieving safe autonomous navigation. However, although many studies have focused on road marking detection using cameras and LIDAR, these technologies encounter inherent constraints: cameras are widely used in the automotive industry because they are cost-effective and capable of detecting colors efficiently. However, like the human eye, they can easily be obstructed by obstacles or weather and handicapped by low lighting conditions. LiDARs, on the other hand, use light pulses to create detailed 3D maps of their surroundings. They offer high precision and accuracy range measurements, making them suitable for mapping environments. However, LiDARs face challenges in differentiating targets beyond their topologies alone (color, roughness, reflectivity), are significantly challenged by inclement weather conditions, and generally offer poor angular resolution at affordable price points. Radars, finally—commonly used for collision avoidance and adaptive cruise control—potentially offer another option for lane detection. Radars perform well in harsh weather and lowlight conditions and can detect objects at long ranges. This long-range detection capability is particularly appealing for the potential sensing of road markings, allowing radar sensors to detect markings at distances sufficient for early warning and navigation purposes. While radars are less affected by environmental conditions, their use for pavement marking detection has remained under-explored. Unlike cameras and LiDARs, pavement markers do not inherently create contrast for radar systems. This challenge highlights the need to develop innovative pavement marker designs tailored for radar based detection.

Recent studies have explored the use of radars for the detection of existing optical road markings without incorporating additional reflective materials. One such approach utilized synthetic aperture radar (SAR) processing with seven radars mounted on the side of a vehicle. While this method eliminates the need for additional infrastructure, its implementation is complex, onerous, and impractical, as it requires multiple radars. Another study introduced a low-profile reflector designed to enable the radar detection of road markings. This design integrates seamlessly into road surfaces and offers a relatively high radar cross-section (RCS). However, its narrow azimuthal field of view of less than 4 degrees poses significant limitations, making it challenging to deploy in practical scenarios where wide angular coverage is necessary to detect pavement markings from the middle of a lane, even at relatively long ranges. Retroreflectivity, commonly used in road markings through coatings or structures like cat's eyes, significantly enhances visibility but remains under-explored for extending the capabilities of automotive radar's vision.

This disclosure proposes a novel vertically polarized, low-cost, and low-profile Substrate-Integrated Waveguide (SIW) horn-based lane marker that can be seamlessly integrated onto the road while providing wide angular coverage and high detectability. To enable the desired retrodirectivity, SIW horn antennas are implemented in a Van Atta configuration, enabling a fully passive phase conjugation technique that achieves a retrodirective performance over the SIW horn antenna's entire beam. The idea is illustrated in FIG. 1 where roads can be equipped with proposed electromagnetic lane markers (or retrodirective devices) 11 that redirects the radar signal back to a radar 12 with high intensity, irrespective of the angle of incidence. In addition, this design allows practical deployments on roads by supporting the required vertical polarization while lying flat on the pavement. Furthermore, its RCS can readily be enhanced by simply stacking these arrays on top of each other in a multilayer structure compatible with standard printed circuit board (PCB) manufacturing. This stacking allows the RCS and the thickness of the marker to be finely traded off between each other.

This section provides background information related to the present disclosure which is not necessarily prior art.

### SUMMARY

This section provides a general summary of the disclosure, and is not a comprehensive disclosure of its full scope or all of its features.

A retrodirective device is presented for use as a road marker. The retrodirective device is comprised of a planar substrate; and a first array of antennas disposed on the substrate and arranged symmetrically in pairs around an axis located in middle of the substrate, where each antenna in the first array of antennas is a substrate-integrated waveguide. Each antenna in the first array of antennas may be further defined as a horn antenna.

In some embodiments, the retrodirective device further includes a second array of antennas disposed on top of the first array of antennas. Additional antenna arrays may be further stacked together without interfering with each other.

In one example retrodirective device is integrated into a top surface of road to serve as lane markers.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a diagram illustrating a vehicle radar interacting with retroreflective road markers.

FIG. 2 is a schematic of an example substrate-integrated waveguide (SIW) horn antenna.

FIG. 3A is a graph of the measured S11 plot of the tapered SIW horn antenna.

FIG. 3B is a graph of a simulated radiation pattern of the tapered SIW horn antenna at 78.5 GHz in the H and E planes.

FIG. 4A is a diagram illustrating a Van Atta antenna array.

FIG. 4B is a schematic illustrating the operating principle of Van Atta antenna array.

FIG. 5 is a graph showing the measured absolute RCS for different configurations for the SIW horn antenna array.

FIG. 6A is a graph showing measured RCS of a five-layer stack of a 3-pair SIW horn antenna array with λ/4, λ/2 and 3λ/4 separations compared to a single 3 pair SIW horn antenna array.

FIG. 6B is a graph showing RCS measurement results comparing the single 3-pair SIW horn antenna array, the two-layer stack of 3-pair SIW horn antenna array with λ/4 separation and the five-layer stack of 3-pair SIW horn antenna array with λ/4 separation.

FIG. 7 is a graph measured RCS of a five-layer stack of a 3-pair SIW horn antenna array with λ/4 in the θ or E plane.

FIG. 8 is a graph of simulated magnitudes of RCS for structural and antenna modes of the SIW horn antenna array.

FIG. 9 is a graph showing the configuration of the radar channels utilizing TDM MIMO with orthogonal time slots.

FIG. 10A is a diagram showing an example embodiment of a retrodirective device having four stacked layers of antenna arrays.

FIG. 10B is a graph showing the measured SNR (in dB) versus range in comparison with the round-trip path loss for the free space versus the two-ray propagation model for a material with ϵr=5.

FIGS. 11A-11C are logarithmic-scale magnitude of 2D FFT images for different dashed line patterns formed with tags separated by 20 cm, 36 cm and 50 cm, respectively.

FIG. 12 is a graph showing measured SNR versus weather conditions for the 5-layer stack of 3-pair SIW horn antenna array.

FIG. 13 is a graph showing the measured SNR versus varying surface materials for the 5-layer stack of 3-pair SIW horn antenna array with λ/4 spacing positioned at a range of 2.1 meters from the radar.

FIG. 14 is a diagram illustrating a Van Atta antenna array with an integrated switch for enabling modulation.

FIG. 15 is a schematic of an example implementation of the switch seen in FIG. 14.

FIGS. 16A-16C are diagrams showing three different configurations for integrating a switch into a substrate integrated waveguide.

FIGS. 17A and 17B are a top view and a bottom view of the waveguide shown in FIG. 16C.

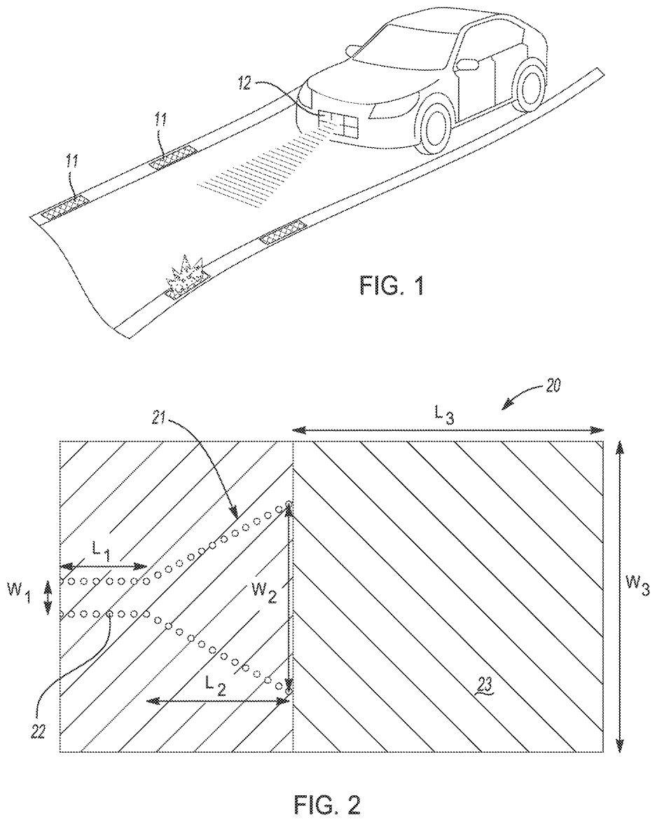

Corresponding reference numerals indicate corresponding parts throughout the several views of the drawings.

### DETAILED DESCRIPTION

Example embodiments will now be described more fully with reference to the accompanying drawings.

The objective of this disclosure is to develop a surface that can be seamlessly integrated into roads while effectively responding to incoming signals from vehicle-mounted radars, regardless of their angle of incidence. This concept is inspired by the behavior of retroreflective road markings, which reflect a significant portion of a vehicle's headlight beams directly back to the driver's eyes, creating a bright and distinct visual contrast between the markings and the surrounding pavement. Similarly, this disclosure seeks to leverage electromagnetic retrodirective surfaces to enable radars to clearly distinguish lanes and markings from the surrounding environment, even in adverse weather conditions. This is achieved with the design of chipless mmWave RFIDs (i.e., mmIDs) by carefully selecting an antenna element to ensure polarization matching between the radar and the proposed mmID tag.

The proposed retroreflective mmID tag is designed for integration on roads to interact with existing vehicle radars, which are primarily used for collision avoidance. These radars are typically front-facing and mounted in the vehicle's front bumper at a commercial height between 40 cm and 60 cm, depending on whether they are used for short- or long-range applications. The radar utilized in this disclosure is the AWR2944EVM radar commercially available from Texas Instruments, featuring four Tx and four Rx channels, each comprising serially-fed patch antenna arrays. It is readily understood that other types of radars fall within the scope of this disclosure.

When mounted vertically, the patch antennas on this radar provide a broadside radiation pattern with vertical polarization. To match this polarization and establish an efficient link between the ground-based antenna and the vehicle-mounted radar, a substrate-integrated waveguide (SIW) horn antenna is proposed because it is capable of delivering a combination of good gain, relatively-wide angular coverage, and, most importantly, can be implemented in a stackable fashion to enhance its gain. While reference is made to a horn antenna, other types of suitable antennas are also contemplated by this disclosure.

FIG. 2 illustrates the geometry for a proposed SIW H-plane horn antenna 20. The proposed antenna consists of the SIW H-plane horn 21, strip transition 22, and extended dielectric slab 23. In an example embodiment, all the parts are constructed on a 20 mil thickness Rogers 4350B substrate with permittivity of ϵᵣ=3.66. For high aperture efficiency and gain, the optimum length of the SIW H-plane horn was first selected given by the Eq. 1 and then optimized in a 3D electromagnetic simulation software (e.g., Ansys HFSS) for best performance:

$${L}_{2} = \frac{{w}_{2}^{2}}{3 {λ}_{d}} \qquad ( 1 )$$

where λ_{d} is the guided wavelength in the dielectric substrate, and w₂ is the width of the SIW horn aperture.

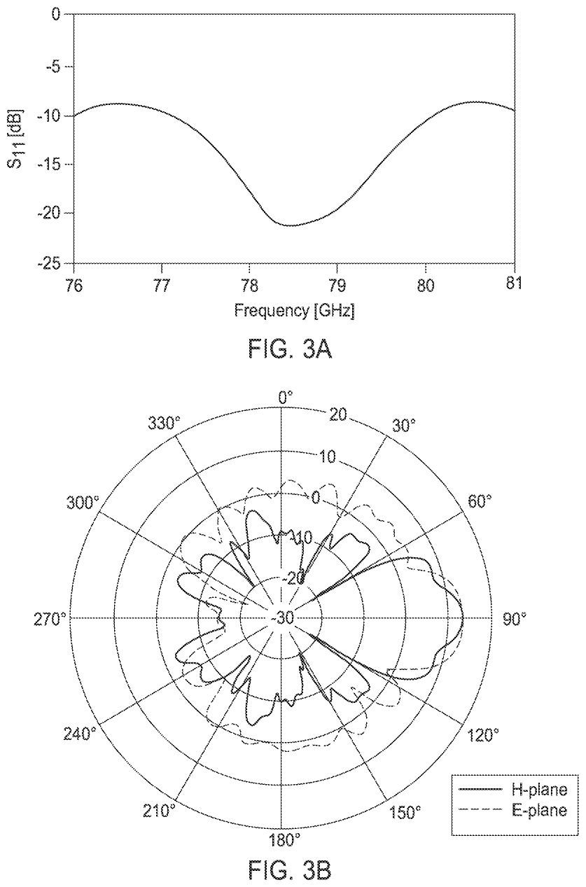

To improve impedance matching between the substrate and air at the SIW horn aperture, a strip transition with dimensions of 0.62 mm×8.46 mm was employed. The distance between the strip transition and the horn is set to 0.127 mm. The antenna structure was finalized in Altium Designer and then fabricated. To enable measurement of its S11, it was matched and connected to a 50Ω, 1.85 mm end-launch connector from Southwest Microwave (part number 1892-03A-6). For this purpose, a tapered λ/4 transmission line transformer was utilized to match the horn antenna's input impedance (185Ω) to the 50Ω impedance. The antenna was simulated in Ansys HFSS then its S11 measured, as shown in FIG. 3A, displaying a very good matching (S11<−10 dB) in the region of interest. The simulated radiation patterns in the E and H planes are also shown in FIG. 3B displaying a front-to-back ratio of 27.37 dB. The radiation patterns are quite symmetric at 78.5 GHz with an E-plane and H-plane 3-dB beamwidth of 26 degrees and 21 degrees, respectively, with a realized gain of 13 dB. These results demonstrate the suitability of the SIW horn antenna for road applications as it enables a wide enough coverage in both azimuth and elevation planes accompanied by a good gain. While exemplary embodiment of SIW horn antenna 20 has been described above with specific components having specific values and arranged in a specific configuration, it will be appreciated that the antennas may be constructed with many different configurations, components, and/or values as necessary or desired for a particular application. The above configurations, components and values are presented only to describe one particular embodiment that has proven effective and should be viewed as illustrating, rather than limiting, the present invention.

In the example embodiment, round metalized via holes are used to create the electric sidewalls although other shapes are contemplated by this disclosure. In comparison with rectangular slots, rounded corners increase the overall mechanical stability, allowing for better metalization, which often cannot be avoided in the fabrication process because of the finite diameter of laser beams in the case of using a laser-based micromachining process. The interruption of current flow along the metalized vias prevents the propagation of TM modes. This occurs because TM modes require an electric field component parallel to the direction of propagation. Since the metalized vias act as perfect electric conductors (PEC), the electric field must remain perpendicular to the vias, effectively blocking TM mode propagation within the SIW. Additionally, the large width-to-height ratio of the SIW facilitates the propagation of TE10 modes, which inherently provide vertical polarization. Since only vertically oriented currents can flow on the via-hole walls, this structure is capable of containing mode patterns with only vertical components of the electric field vector. Mode patterns with horizontal components of the electric field vector have horizontal components of the current distribution on the via-hole walls, which will radiate.

Note that the SIW structures are periodic geometries, which is subject to the guided-wave phenomena of all periodic waveguides such as bandgap (stopband) effects. Such stopbands, caused by the distributed Bragg reflection, occur around frequencies at which the periodic spacing p is equal to a multiple of half a guided wavelength. Therefore, in order to ensure that the synthesized waveguide section is free from radiation and leakage losses, the parametric effects of p and d were analyzed. To simplify the analysis, dielectric and conductor losses were not considered, and the loss was assumed to originate solely from radiation. The following geometric constraints were established to minimize return and leakage losses:

$$d < \frac{{λ}_{g}}{5} \qquad ( 2 )$$

$$p \leq 2 d \qquad ( 3 )$$

where d is the diameter of the vias, p is the period distance between them, and λ_{g} is the guided wavelength.

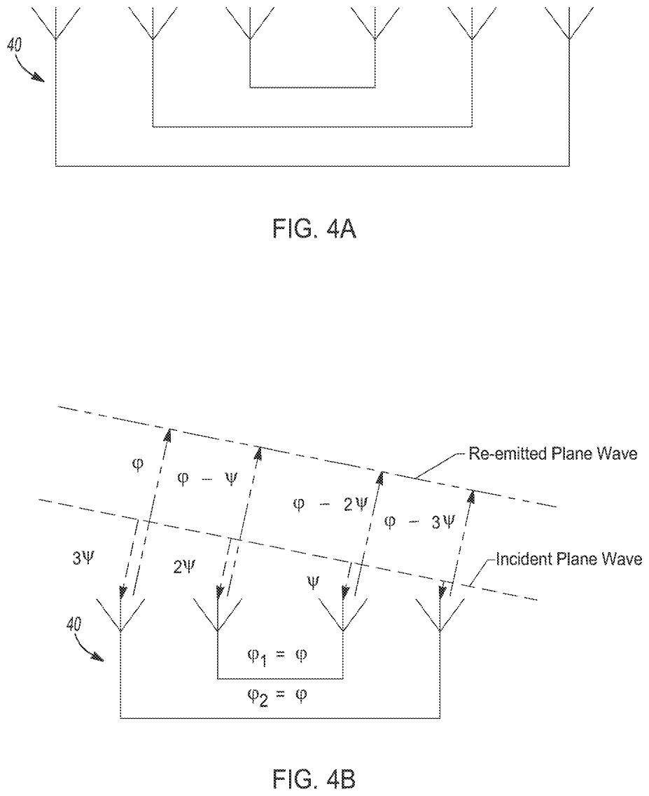

Simply arraying the SIW horn element presented in the previous section leads to a high gain but compromises the field of view. With reference to FIGS. 4A and 4B, a retrodirective device 40 is presented that simultaneously achieves a high gain while maintaining a wide field of view essential for the application of interest. Retrodirective arrays or reflectarrays have been widely explored in the RF and mmWave domain to enhance the communications range, due to their ability to focus the energy back in the direction of incidence. Their benefits are particularly reaped at high frequencies (24 GHz and above) where electrically large apertures can be designed to achieve a combination of high gain and wide angular coverage.

In an example embodiment, a retrodirective device 40 employs a Van Atta array as shown in FIG. 4A. The retrodirective device 40 is comprised of an array of antennas disposed on a planar substrate. The array of antennas arranged symmetrically in pairs around an axis or center of symmetry located in the middle of the structure. In the example embodiment, the antennas forming the array of antennas are further defined as horn antennas. These structures exhibit notable characteristics when all connecting lines are of equal electrical lengths. In such a setup, the received wave is re-emitted in-phase in the direction of the incoming radar signal. The power received by a monostatic radar in front of the mmID tag can be expressed using the monostatic radar equation:

$${P}_{v}^{r} = {P}_{v}^{t} \frac{{G}^{2} {λ}^{2}}{{( 4 π )}^{3} {R}^{4}} {σ}_{v v} \qquad ( 4 )$$

is the vertically-polarized received power,

$${P}_{v}^{t}$$

is the vertically-polarized transmitted power, G is the gain of the antennas on the radar, λ is the wavelength, R is the distance between the radar and the tag, and σ_{w} represents the radar cross-section (RCS) of the tag when both the incident and scattered electromagnetic waves are polarized vertically. The operating principle for the retrodirective device 40 is shown in in FIG. 4B.

According to Equation 4, the target is more detectable when the RCS increases, which in turn depends on the aperture size. For this purpose, SIW horn antenna arrays of different sizes were designed and fabricated on RO4350 substrate with a thickness of 0.508 mm. In the example embodiment, the overall dimensions of these structures are: 1 pair (19.93 mm×33.65 mm), 2 pair (37.93 mm×37.46 mm), and 3 pair (56 mm×40.76 mm). Structures having more or less antenna pairs are also contemplated by this disclosure.

To minimize coupling between adjacent antennas, simulations were conducted in HFSS to determine an appropriate distance between them. Specifically, the analysis involved observing the radiation patterns of two adjacent antennas under two scenarios: when one antenna was excited individually and when both antennas were excited simultaneously. The decision to limit the design to a three-pair configuration was driven by the desire to maintain the transmission line losses below 3 dB to optimize the performance of the Van Atta architecture.

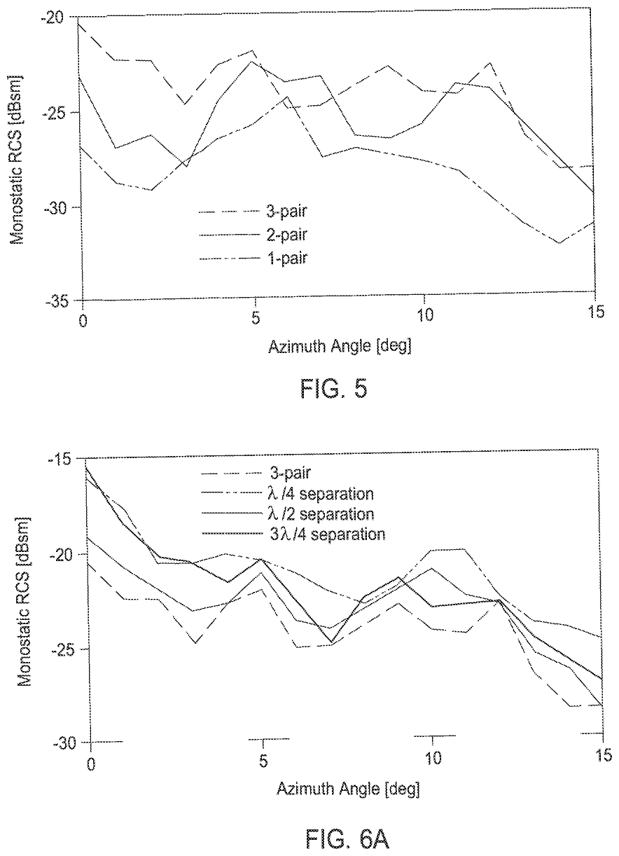

Unlike most structures that feature at least one interfacing waveguide port, the Van Atta reflectarrays are uniquely characterized by their reflecting property or, more specifically, their monostatic RCS, as both the transmitter and receiver are positioned in the same direction. Typically, to achieve optimal characterization measurements, positioning the reflectarray inside an anechoic chamber, backed by RF absorbing surfaces, is advisable. However, the large bandwidth—and associated high resolution—of the testing radar allows for a spatial isolation sufficient to enable testing inside a relatively busy laboratory environment. Throughout this disclosure, an AWR2944EVM automotive radar from Texas Instruments was utilized for all measurements and RCS characterizations. For this test, the automotive FMCW radar was placed facing the target at an approximate distance of 70 cm as shown in FIG. 5A. The Van Atta array was mounted horizontally on a very thin plexiglass structure, providing the vertical polarization that matches that of the radar, and elevated away from highly reflective surfaces such as the rotating metallic mounting structure used for the angular control. To perform the RCS measurements, the FMCW radar data was processed and the range FFT was plotted to extract the received power at the location of the target. In the FFT analysis, the power corresponding to the target's distance is aggregated by summing the bins that contribute to the target's location. This process was repeated across φ angles from 0 degrees to 15 degrees at one degree increments. A 2.175″ diameter aluminum sphere was used as a reference target, for the accurate normalization of the RCS measurements.

FIG. 5 shows the measured monostatic absolute RCS of different Van Atta sizes in the H plane—when φ was varied from 0 degrees to 15 degrees. The measured results display an increase in RCS with the increase in the number of Van Atta pairs with a maximum measured RCS of around −20 dBsm with 3 pair compared to −27 dBsm with a 1 pair. The measured RCSs of different SIW horn pairs display at least a 10 dB increase in comparison to Yagi Uda Van Atta pairs, and maintain a relatively stable response over a 15 degree angular range (given the symmetry of the proposed architecture) and demonstrating its retrodirective capabilities in the H plane.

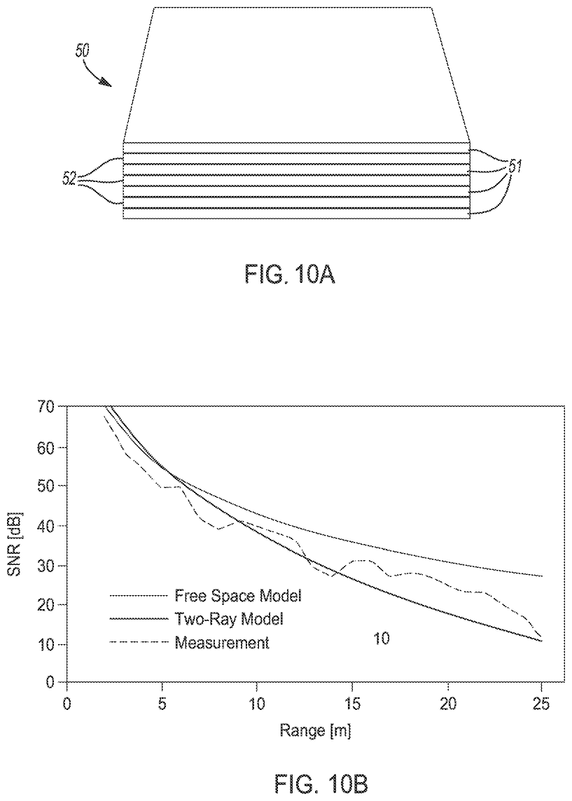

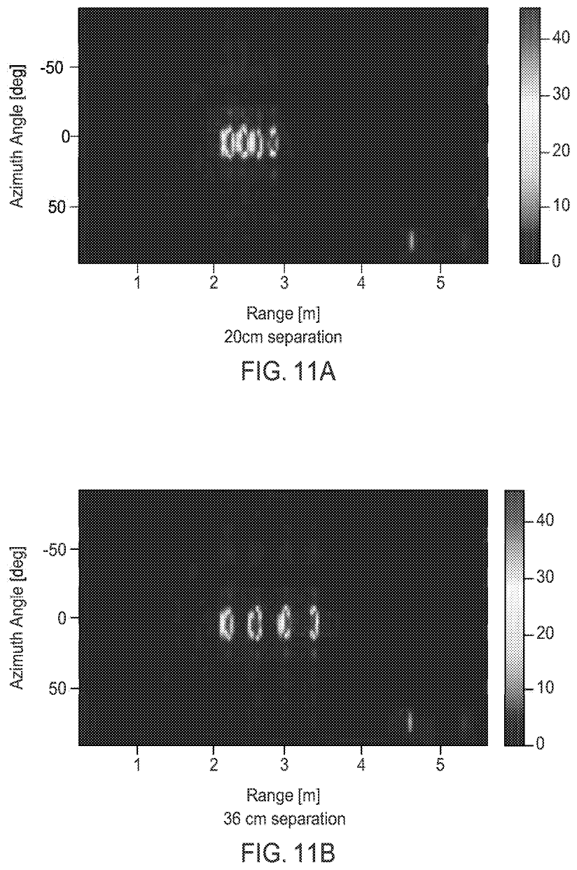

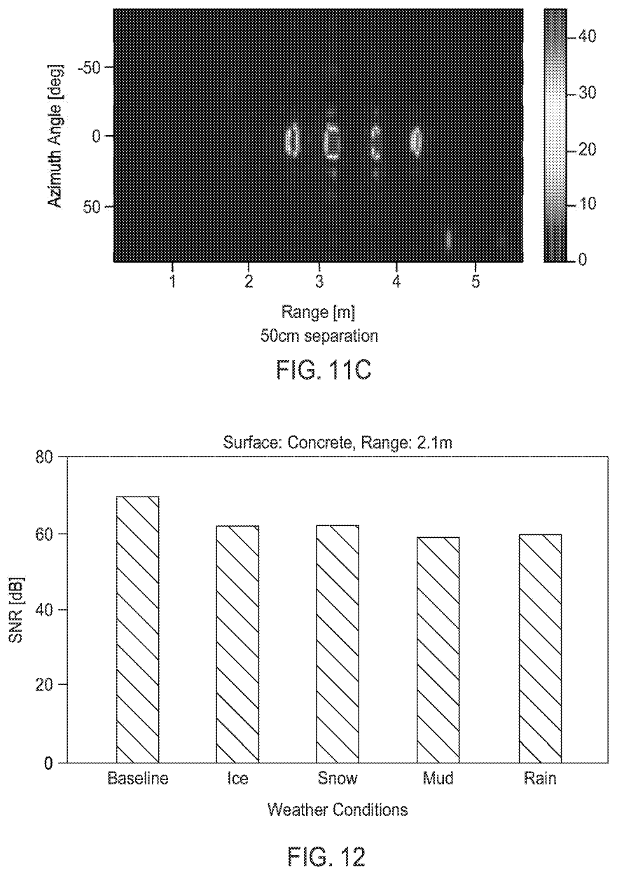

While this new Van Atta architecture provides a relatively good RCS, it is always desirable to further enhance the tag's detectability. The uniqueness of this proposed SIW horn antenna array design is the ability to stack it in a multilayer fashion while maintaining a very low profile close to the ground and providing vertical polarization. FIG. 10A is a diagram depicting an example embodiment of a retrodirective device 50 have stacked layers of antenna arrays. In this example, the retrodirective device 50 has four stacked layers of antenna arrays 51; each layer separated by an insulating layer 52. In the example embodiment, the insulating layers are comprised of plexiglass although other suitable materials are contemplated by this disclosure. Again, while four stacked layers of antenna arrays are shown, the retrodirective device may include more or less layers of antenna arrays.

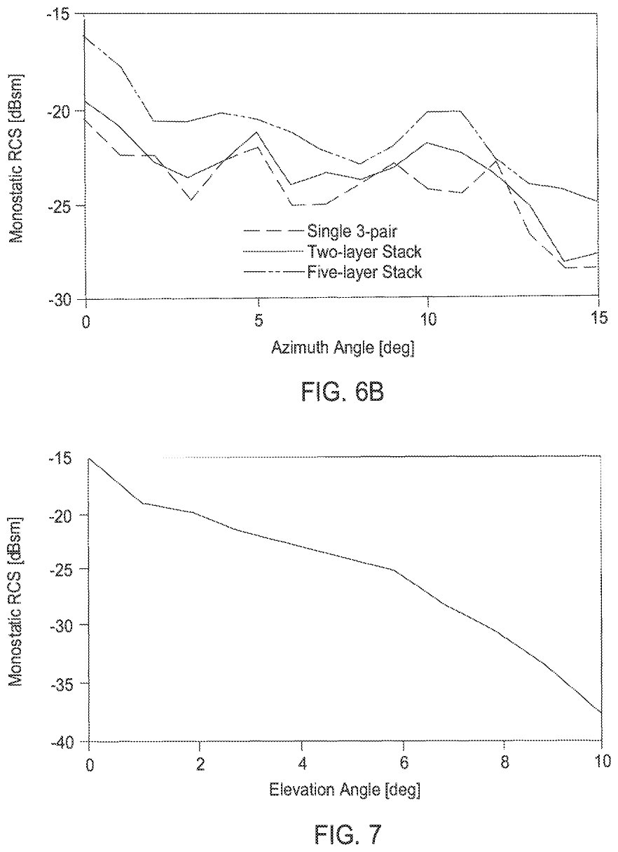

Furthermore, the SIW architecture for the retrodirective device confines the fields inside the substrates, thereby significantly limiting the coupling between the stacked layers. In the following experiment, the focus is on identifying the optimal separation between the different Van Atta pairs, as well as a practical number of layers for the final design. To evaluate a stack of Van Atta pairs with different separations, the absolute RCS of a five-layer stack of a 3-pair SIW horn Van Atta was measured for different separations, including λ/4, λ/2, and 3λ/4, and compared to a single 3-pair SIW horn Van Atta, as shown in FIG. 6A. Given that the results demonstrate a superior RCS performance for λ/4 and 3λ/4 separations, smaller separation was used to maintain a lower profile.

Next, the influence of the number of layers on the measured RCS was evaluated. FIG. 6B presents the RCS measurement results for the single 3-pair SIW horn Van Atta, the two-layer stacked 3-pair SIW horn Van Atta with λ/4 separation, and the five-layer stacked 3-pair SIW horn Van Atta with λ/4 separation, both in the φ or H-plane. The results show an increase in RCS as the number of stacked layers increases, with the five-layer stacked 3-pair SIW horn Van Atta achieving a peak RCS of −16 dBsm, while the single layer 3-pair SIW horn Van Atta without stacking exhibits a maximum RCS of −21 dBsm. Finally, the absolute RCS of a five-layer stack of a 3-pair SIW horn Van Atta array was measured across elevation angles and is plotted in FIG. 7. The results indicate a 10 dB elevation beamwidth of 12 degrees.

The signal re-emitted from any tag consists of several components, including noise, interfering reflections from the environment, interference from nearby RF sources, a reflection from the antenna's structure (referred to as the structural mode), and the information-carrying component (referred to as the antenna mode). The distinction between these two modes can be understood by considering a single SIW horn antenna. As a metallic object, the antenna reflects electromagnetic waves in a manner determined solely by its structural shape, which corresponds to the structural mode. However, when properly excited with a well-designed matching network, the structure also operates as an antenna, in what is characterized as the antenna mode. In this mode, the antenna absorbs a portion of the signal and re-emits it. Due to the inherent properties of SIW horn antennas, which feature a relatively large ground plane as part of their structure, the contribution of the structural mode is naturally present and, in some cases, comparable to or greater than the antenna mode. This is not a limitation of the design but rather a characteristic of SIW horn antennas.

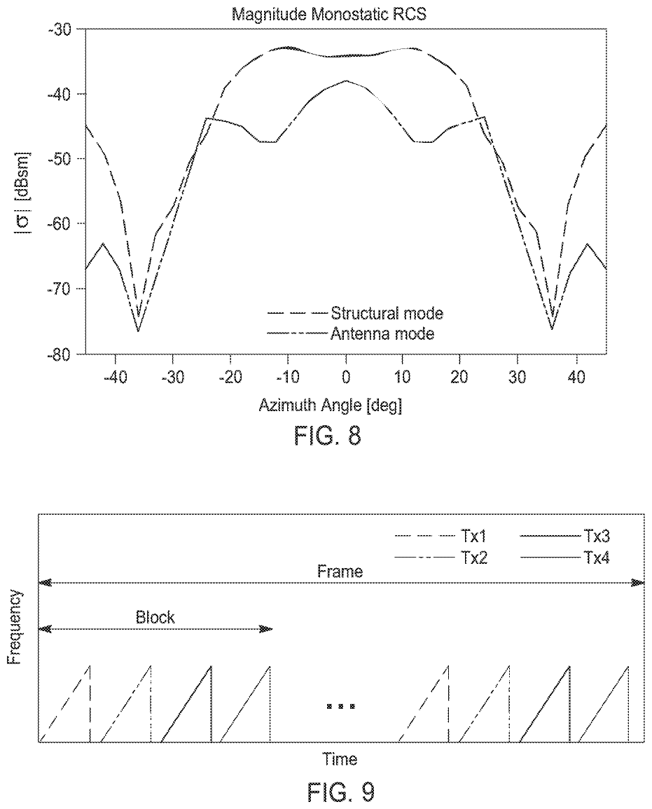

To analyze the behavior of the antenna and structural modes, an SIW horn antenna is considered. By varying the load at its feed and calculating the differential RCS, both modes can be evaluated. First, when the load at the feed is open, the simulated RCS represents the sum of the antenna mode and the structural mode. Next, when the load at the feed is shorted, the simulated RCS represents the negative of the antenna mode added to the structural mode. By summing these two simulated RCS values and dividing by two, one can isolate the structural mode. Similarly, subtracting the two RCS values and dividing by two isolates the antenna mode. Since standard RCS does not include phase information, one can use complex RCS (the square root of RCS) to analyze the phase of both antenna and structural modes. Using the aforementioned process, the simulated magnitude of the RCS for both the structural and antenna modes is shown in FIG. 8.

It was observed that the structural mode offers consistently higher RCS than the antenna mode. Therefore, the antenna mode could seem superfluous. However, when arrayed, the structural mode operates as a specular reflector, leading to very narrow angular coverages. By contrast, the antenna mode can be engineered through the Van Atta scheme to be retrodirective, thereby offering a theoretically constant angular coverage as the size of the array scales. The combined effects of these two modes can be observed in FIG. 5 and FIG. 6, where a sharp peak is present at broadsight (0 degrees) before transitioning to a smoother region as the angle of incidence increases. The effect is further amplified with the number of antennas, as the array factor becomes more directive. Without the antenna mode, only the sharp peak at broadsight would exist, leaving oblique interrogators incapable of detecting the marker.

Next, the tag's performance is evaluated in realistic conditions with an automotive radar. The following describes the different experimental setups along with the achieved results for the tag's performance vs range, its ability to create distinctive patterns detectable by the radar, and its behavior under different environmental conditions. The 5-layer 3-pair Van Atta tags with λ/4 spacing are used in these experiments unless otherwise indicated.

In the experimental setup, the AWR2944EVM automotive radar from Texas Instruments was configured to chirp from 76.68 GHz to 81 GHZ, achieving a bandwidth of 4.32 GHz and an associated range resolution of 3.2 cm. Each chirp lasted 150 μs, with data sampled starting 6 μs after the beginning of the chirp. A total of 1440 points were sampled per chirp at a rate of 10 Msps. The radar features 4 transmit (Tx) and 4 receive (Rx) channels, with its MIMO functionality enabled using Time-Division Multiplexing (TDM), as shown in FIG. 9. To implement TDM MIMO, separate time slots were allocated to each transmit antenna, ensuring orthogonal signals that prevent interference. This approach allowed the receiver antennas to decode each transmitter's signal based on the corresponding time slot. Each frame was divided into several blocks, with each block consisting of four time slots, one for each transmit antenna (Tx). Consequently, the chirp sequence length matched the number of transmitters (4 in this case) and was repeated 128 times per frame, corresponding to the total number of chirps.

To estimate the range and angle of arrival (AoA) of the tag signals, data from a single radar chirp was processed using a two-step Fast Fourier Transform (FFT) procedure. First, a time-FFT was performed along each chirp in the frame to move to range space. Subsequently, a second angle-FFT was applied over the orthogonal dimension of the channels to move to angular space. For enhanced accuracy, the angle-FFT was zero-padded by a factor of 32. This process was repeated for all chirps within the frame, and the magnitude of the 2D (range/angle) spectrum was averaged. Finally, the peak in 2D space associated with the tag was detected and its amplitude was measured and tabulated. To implement this approach, the radar was positioned at a standard commercial height of 40 cm above the ground, consistent with radars mounted on the front bumpers of vehicles for collision avoidance applications. Various tags were placed at different ranges and angles in front of the radar and were successfully detected. These tags included a multi-layer stack of 3-pair SIW horns with λ/4 separations, and a dashed pattern formed by four stacked tags with varying separations. The separations between adjacent tags were designed to exceed the radar's range resolution (3.2 cm), allowing them to be detected as distinct targets.

To evaluate the range detection capability of the proposed tag, the SNR of its response was measured at multiple distances. The SNR was determined using the following procedure: the signal level was obtained by computing the power spectrum of the range bin and angular bin corresponding to the tag. The noise level was estimated by averaging the power spectrum of the neighboring range bins around the target. The SNR, expressed in dB, was then determined by subtracting the noise level from the signal level. The tag was positioned on an asphalt surface, and the measurements were performed under moist weather conditions. As a rule of thumb, a tag is considered well-detected by the radar when the SNR is 10 dB or higher. FIG. 10B presents the measured SNR of a 5-layered stack of 3-pair SIW horn Van Atta reflectors with λ/4 separation between adjacent layers with varying ranges. The experimental results demonstrate that the radar successfully detected the proposed tag at distances up to 25 m, with an SNR of 11 dB. These findings highlight the structure's strong potential for practical applications in real-world scenarios.

It is worth noting, however, that the SNR vs range trend differs from what could be, a priori, expected. As shown in FIG. 6B, the measured RCS of a 5-layer stack of 3-pair SIW horns with λ/4 separation is −16 dBsm. All associated radar parameters are listed in Table I.

TABLE 1

| Parameter | Value | |
|---|---|---|
| Pt (Transmit Power) | 13.5 | dBm |
| G_{RX} (Receiver Gain) | 19 | dBi |
| G_{TX} (Transmitter Gain) | 12 | dBi |
| c (Speed of Light) | 3 × 10⁸ | m/s |
| RCS_{detection} (σ) | −16 | dBsm |
| N (Number of Chirps) | 128 | |
| Tᵣ (Chirp Time) | 150 | μs |
| f_{c} (Carrier Frequency) | 78.5 | GHz |
| NF (Noise Figure) | 12 | dB |
| SNR_{det} (Minimum SNR required to detect an object) | 10 | dB |
| KT (Thermal Noise Power) | 3.77 × 10⁻²¹ | |
| IFₘₐₓ (Maximum Intermediate Frequency) | 15 | MHz |
| S (Slope of transmitted chirp) | 30 | MHz/μs |

Using the parameters in Table I and the free-space model underlying Eq. 5, the range detection of the proposed 5-layer stack of 3-pair SIW horns with λ/4 separation is analytically determined to be 90 m—3.6× the measured maximum range.

$${R}_{max} = {( \frac{{P}_{t} {G}_{R X} {G}_{T X} {c}^{2} σ N {T}_{r}}{{( 4 π )}^{3} {f}_{c}^{2} \cdot kT \cdot NF \cdot {SNR}_{det}} )}^{\frac{1}{4}}$$

where Rₘₐₓ is the maximum expected range and the other parameters are defined in Table I.

This can be attributed to the close proximity of the tag to the pavement. Indeed, in these conditions, a two-ray (one direct and the other bouncing on the pavement) model is much more appropriate. The round-trip path loss estimated by this model for a pavement permittivity ϵᵣ=5—compared side-by-side with its free-space path loss counterpart—is shown in FIG. 10. It displays an additional loss of approximately 20 dB at 25 m, which is equivalent to a free-space range reduction of 3.17×, in line with our measurements.

This section explores the ability of the automotive radar to recognize and classify different patterns of pavement markers created with mmID tags. Pavement markers—just like paint or road studs—can have a variety of patterns, each serving a specific purpose for guiding or regulating traffic. Common patterns include solid lines, dashed lines, or a combination of both. To create a certain pattern, stacked mmID tags were placed in various configurations and the automotive radar was used to image the ground in 2D range-azimuth space. Specifically the focus is on the dashed line model that was realized using multiple tags with different separations. In the experimental setup, four tags are placed in front of the radar, each consisting of a 5-layer stack of 3-pair SIW horn Van Attas with λ4 spacing, with the closest tag to the radar being placed at 2.1 m away. The tags were tested with three different separations: 20 cm, 36 cm, and 50 cm, forming three different dashed line patterns. Similar to the previous SNR experimental setup, the radar was positioned at a standard commercial height of 40 cm above the ground. Due to the narrow elevation beamwidth of the utilized radar, which has a reported 3-dB elevation beamwidth of 3 degrees, the radar was tilted approximately 5 degrees to ensure a reasonable radiation pattern to properly detect the targets. FIGS. 12A-12C present the 2D FFT images of the dashed line pattern with these separations. The different heat maps demonstrate the ability of the radar to accurately detect and recognize different dashed lines with increasing separations, proving that chipless mmID tags have the potential to generate diverse lane markings for radars.

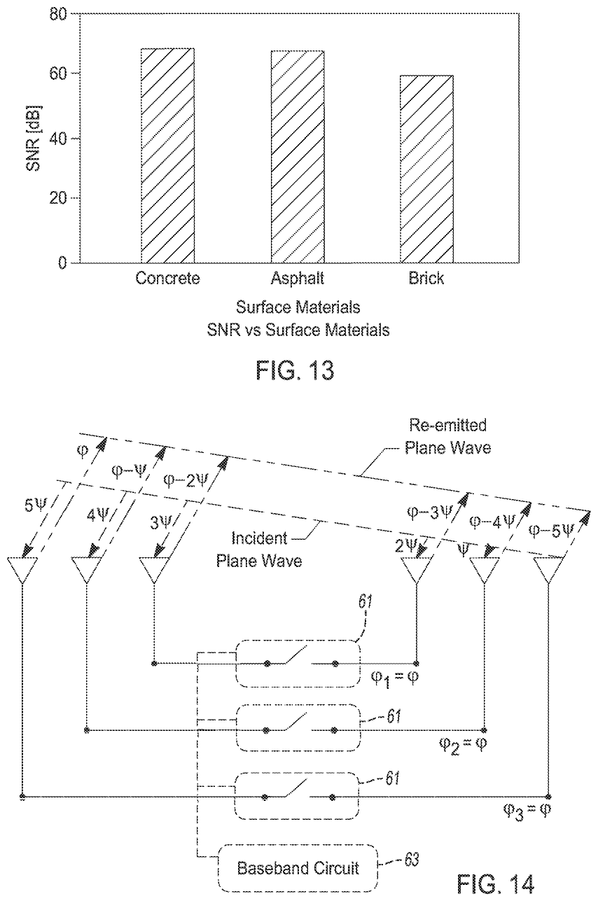

To evaluate the performance of the proposed tag under different weather conditions, it is essential to measure the SNR to understand how these conditions influence the tag's detectability. Following the method above, the SNR was measured for the 5-layer stack of 3-pair SIW horn Van Attas with λ/4 separation placed on a concrete surface at a range of 2.1 m under four different weather conditions: ice, snow, mud, and rain. FIG. 13 presents the measured SNR across these conditions. It is observed that the SNR remains relatively high across all weather conditions, with the highest value recorded under ice at 61.75 dB, followed by snow at 61.6 dB, mud at 59.44 dB, and rain at 59.34 dB, compared to the 69.13 dB baseline without any adverse weather interference. These results show excellent robustness and indicate that the tag maintains strong detectability even under challenging weather conditions.

When the radar wave is transmitted and reaches the tag placed on different surface materials, the surface properties, including permittivity and roughness, play a crucial role in determining the strength of the reflected wave and the resulting SNR. The permittivity of the material affects how much of the signal is absorbed and dissipated, while surface roughness governs the scattering of the reflected wave, affecting one of the two paths of the two-ray model introduced above.

To evaluate the performance of the proposed tag on different surface materials on which tag is placed, it is important to measure the SNR to understand how these conditions influence the tag's detectability. Following the method mentioned above, the SNR of tags when placed on different surfaces was measured. More specifically, concrete, asphalt, and brick surfaces on which the 5-layer stacks of 3-pair SIW horn Van Attas with λ/4 separation were placed at ranges of 2.1 m from the radar. FIG. 13 presents the measured SNR across these conditions. It is observed that the noise levels remain relatively constant while the SNRs remain relatively high across all surfaces, with the highest value recorded under concrete at 69.13 dB, followed by asphalt at 68.14 dB, brick at 59.93 dB. Such results are consistent with the variations predicted by the two-ray model for materials ranging in permittivity from 4 to 5, 3 to 4, and 2 to 3, respectively. This also, more importantly, indicates that the tag maintains strong detectability even when placed on a wide variety of materials used for road pavements.

In another aspect, the retrodirective device 60 is configured to modulate signals redirected by the Van Atta arrays. To achieve modulation, a switch is required as seen in FIG. 14. The key idea is to control wave propagation through the Van Atta structure. In one state, the wave efficiently passes from port 1 to port 2; whereas, in the other, it is blocked. These two states define the proposed switch. It is envisioned that the proposed switches can be controlled by a baseband circuit, which governs their state transitions to achieve the desired modulation. Modulating the redirected signal improves detections and enhances SNR as well as Angle of Arrival estimations. Modulation may also be used to encode data in the redirected signals.

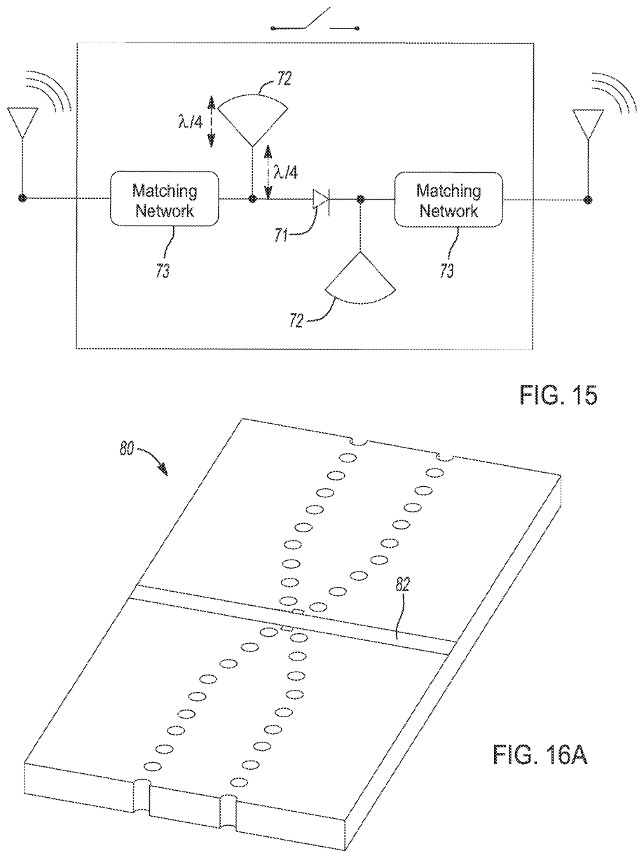

FIG. 15 depicts an example implementation of a switch interconnected between two antennas. In this example, a Schottky diode 71 (e.g., Macom MA4E1317) is used to create two states based on the applied voltage. To isolate RF signals while allowing DC biasing, quarter-wavelength radial stubs 72 are placed before and after the diode 7. At the operating frequency, these stubs 72 act as open circuits at their ends but transform into short circuits at the connection point. A quarter-wavelength transmission line then converts this short circuit back into an open circuit, effectively blocking RF signals from the Van Atta array while preserving DC biasing. To ensure proper integration with the Van Atta ports (500), matching networks 73 may be used on both sides of the diode. The above configuration is presented only to describe one particular embodiment that has proven effective and should be viewed as illustrating, rather than limiting, the present invention. Moreover, it is envisioned that the antennas may be interconnected by other types of switches, such as a transistor.

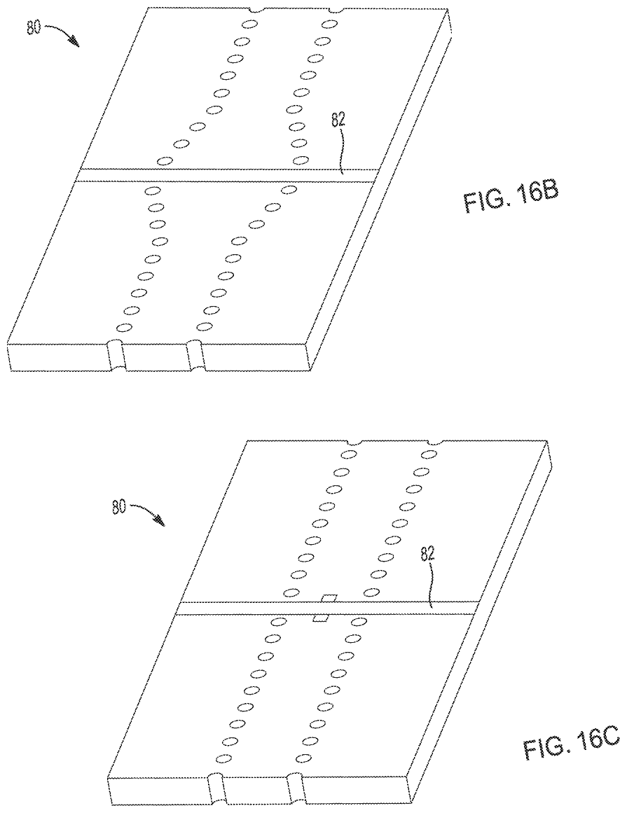

FIGS. 16A-16C show three different configurations for integrating a switch into a substrate integrated waveguide 80. Intersecting line 82 corresponds to the diode in the electromagnetic simulation software (e.g., HFSS) and the antennas are electrically coupled to opposing ends (i.e., top and bottom ends) of the waveguide 80. Tapering may be used for impedance matching to the antennas for example as seen in FIG. 16A. Different configurations are possible based on the diode input impedance and the characteristic impedance of the antenna.

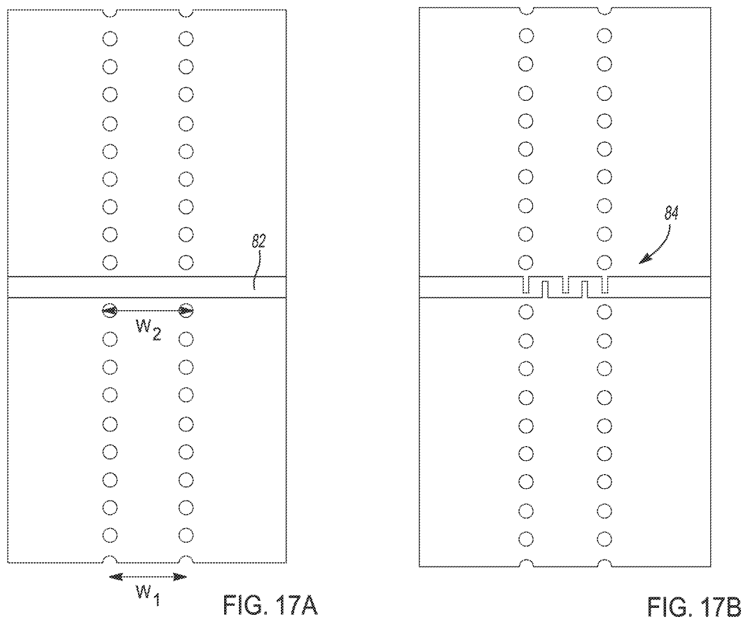

FIGS. 17A and 17B show a top view and a bottom view of the configuration shown in FIG. 16C. Of note, an interdigitated capacitor 84 is integrated into the bottom layer. In fabrication, the goal is to bias one side of the diode with a positive voltage and the other side with a negative voltage. Since both sides of the diode are connected to the bottom layer through vias, applying opposite bias voltages would create a short. Therefore, a gap is introduced in the bottom layer that passes RF while blocking DC, implemented using an interdigitated capacitor. In this example, the number of fingers of the interdigitated capacitor 84 was optimized to five, and the RF performance remains unchanged after adding the capacitor while proper biasing can still be applied.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A retrodirective device for use as a road marker, comprising:
a planar substrate; and
a first array of antennas disposed on the substrate and arranged symmetrically in pairs around an axis located in middle of the substrate, wherein antennas in each pair are connected to each other and each antenna in the first array of antennas is a substrate-integrated waveguide.

2. The retrodirective device of claim 1 wherein each antenna in the first array of antennas is further defined as a horn antenna.

3. The retrodirective device of claim 2 wherein each antenna in the first array of antennas is flared along H-plane.

4. The retrodirective device of claim 2 wherein the first array of antennas includes three pairs of antennas.

5. The retrodirective device of claim 2 wherein the substrate-integrated waveguide is implemented by a plurality of via holes formed in a dielectric substrate such that
$$d < λ / 5 and p \leq 2 d$$
where d is diameter of via holes, p is distance between via holes and λ is guided wavelength.

6. The retrodirective device of claim 1 further comprises a second array of antennas disposed on top of the first array of antennas.

7. The retrodirective device of claim 1 further comprises a circuit interfaced with the first array of antennas and operates to modulate signals redirected by the first array of antennas.

8. The retrodirective device of claim 6 wherein the circuit includes a switch for each pair of the symmetric pairs in the first array of antennas, where each switch interconnects the antennas in the symmetric pairs.

9. The retrodirective device of claim 1 is integrated into a top surface of a road.

10. A retrodirective device for use as a road marker, comprising:
a planar substrate;
a first array of antennas disposed on the substrate, where the antennas in the first array of antennas are substrate integrated waveguides and are arranged symmetrically in pairs around an axis located in middle of the substrate, such that antennas in each antenna pair are connected to each other; and
two or more arrays of antennas stacked on top of the first array of antennas, where the antennas in the two or more arrays of antennas are substrate integrated waveguides and are arranged symmetrically in pairs around the axis, such that antennas in each antenna pair are connected to each other.

11. The retrodirective device of claim 10 wherein each antenna in the first array of antennas is further defined as a horn antenna.

12. The retrodirective device of claim 11 wherein each antenna in the first array of antennas is flared along H-plane.

13. The retrodirective device of claim 10 wherein the two or more arrays of antennas is comprised of four arrays of antennas.

14. The retrodirective device of claim 10 wherein separation between the two or more arrays is λ/4, where λ is wavelength incident thereon.

15. The retrodirective device of claim 10 is integrated into a top surface of a road.
